(19) United States
(12) Patent Application Publication
(10) Pub. No.: US 2018/0299901 A1
(43) Pub. Date: Oct. 18, 2018

(54) Hybrid Remote Retrieval System

(71) Applicant: Walmart Apollo, LLC, Bentonville, AR (US)

(72) Inventor: Robert Cantrell, Herndon, VA (US)

(21) Appl. No.: 15/951,579

(22) Filed: Apr. 12, 2018

Related U.S. Application Data
(60) Provisional application No. 62/486,120, filed on Apr. 17, 2017.

(51) Int. Cl. G05D 1/02; B25J 11/00; G06Q 30/06; G06F 17/30; G06T 15/00; G06T 19/00; B25J 19/02; B25J 5/00

(52) U.S. Cl. CPC G05D 1/0246; B25J 11/008; G06Q 30/0601; G06F 17/3079; G05D 2201/0216; G06T 19/003; B25J 19/023; B25J 5/007; G06T 15/005

(57) ABSTRACT

Described in detail herein are systems and methods for a hybrid remote retrieval system. The hybrid remote retrieval system includes both physical and virtual elements and enables a remotely located user to retrieve physical objects from a facility. A first video device is configured to transmit a video signal a first computing system. The first computing system receives the video signal from the first video device, generates a virtual representation of the physical facility, transmits the virtual representation of the physical facility that includes a current location of the video signal and a movable storage apparatus in the physical facility to a second computing system, subsequently receives a retrieval request associated with a virtual representation of a physical object from the second computing system and transmits the retrieval request to the physical facility for execution.

### CROSS-REFERENCE TO RELATED PATENT APPLICATIONS

This application claims priority to U.S. Provisional Application No. 62/486,120 filed on Apr. 17, 2017, the content of which is hereby incorporated by reference in its entirety.

### BACKGROUND

A group of products that are available in a physical facility to be selected by an individual may change over time. For example, the products may be moved or may be misplaced during a resupply operation. Therefore, to confirm the presence and availability of the product the individual may walk through the facility to view and/or retrieve the product at an assigned location.

### BRIEF SUMMARY

In one embodiment, a hybrid remote retrieval system includes a first video device is configured to operate in a physical facility. The first video device is configured to transmit a video signal. A movable storage apparatus is configured to receive physical objects and move within the physical facility. A first computing system is operatively coupled to a database holding information regarding the plurality of physical objects. The first computing system configured to execute a virtual retrieval module. The virtual retrieval module when executed, receives the video signal from the first video device accompanied by data used to determine a current location within the physical facility at which the video signal was generated and generates a virtual representation of the physical facility including virtual representations of the plurality of physical objects at locations within the physical facility that are determined based at least in part on the video signal, and a virtual representation of the movable storage apparatus at the current location within the physical facility. The virtual retrieval module further transmits the virtual representation of the physical facility to a second computing system, receives a retrieval request associated with a virtual representation of a physical object from the second computing system and transmits the retrieval request to the physical facility. The second computing system is operatively coupled to the first computing system and is configured to execute a hybrid display module that. The hybrid display module when executed receives and generates a display of the virtual representation of the physical facility, receives user input indicating the retrieval request and transmits the retrieval request to the first computing system. The retrieval request is performed in the physical facility and the physical object is stored in the movable storage apparatus.

In one embodiment, a hybrid remote retrieval method includes, transmitting, via a first video device operating in a physical facility, a video signal, receiving, via a movable storage apparatus, physical objects and move within the physical facility. The method further includes executing, via a first computing system operatively coupled to a database holding information regarding the physical objects, a virtual retrieval module. The method further includes receiving, via the virtual module, the video signal from the first video device accompanied by data used to determine a current location within the physical facility at which the video signal was generated, generating, via the virtual module, a virtual representation of the physical facility. The virtual representation of the physical facility include virtual representations of the plurality of physical objects at locations within the physical facility that are determined based at least in part on the video signal, and a virtual representation of the movable storage apparatus at the current location within the physical facility. The method further includes transmitting, via the virtual module, the virtual representation of the physical facility to a second computing system, receiving, via the virtual module, a retrieval request associated with a virtual representation of at least one of the plurality of physical objects from the second computing system, transmitting, via the virtual module, the retrieval request to the physical facility, executing, via the second computing system operatively coupled to the first computing system, a hybrid display module, receiving, via the hybrid display module, and generates a display of the virtual representation of the physical facility, receiving, via the hybrid display module, user input indicating the at least one retrieval request and transmitting, via the hybrid display module, the at least one retrieval request to the first computing system. The retrieval request is performed in the physical facility and the physical object is stored in the movable storage apparatus.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a schematic diagram of an exemplary arrangement of physical objects disposed in a facility according to an exemplary embodiment;

FIG. 2 is a schematic diagram of a virtual representation of the arrangement of physical objects disposed in a facility according to an exemplary embodiment;

FIG. 3 illustrates an exemplary hybrid remote retrieval system in accordance with an exemplary embodiment;

FIG. 4 illustrates a block diagram an exemplary computing device in accordance with an exemplary embodiment; and

FIG. 5 is a flowchart illustrating a process implemented by a hybrid remote retrieval system according to an exemplary embodiment.

### DETAILED DESCRIPTION

Described in detail herein are systems and methods for a hybrid remote retrieval system. The hybrid remote retrieval system includes both physical and virtual elements and enables a remotely located user to retrieve physical objects from a facility. A first video device can transmit a video signal from a facility. A first computing system can execute a virtual retrieval module that receives the video signal from the first video device accompanied by data used to determine a current location within the physical facility at which the video signal was generated. The virtual retrieval module can generate a virtual representation of the physical facility. The virtual representation of the physical facility includes virtual representations of the physical objects at locations within the physical facility that are determined based at least in part on the video signal. The virtual representation of the physical facility also may include a virtual representation of a movable storage apparatus at the current location within the physical facility. The virtual retrieval module can also transmit the virtual representation of the physical facility to a second computing system and receive a retrieval request associated with a virtual representation of the physical objects from the second computing system. The virtual retrieval module can transmit the retrieval request to the physical facility. The second computing system can execute a hybrid display module and be operatively coupled to the first computing system. The hybrid display module can receive and generate a display of the virtual representation of the facility. The hybrid display module can also receive user input indicating a retrieval request associated with at least one of the physical objects depicted in the virtual representation. The hybrid display module can transmit the retrieval request to the first computing system. The retrieval request is performed in the physical facility and the physical object is stored in the movable storage apparatus.

In one embodiment, the first video device can be secured to a robotic device configured to navigate autonomously, manually or pursuant to direction of a remote user. For ease of explanation the robotic device will be referred to herein as a semi-autonomous robotic device but the term should be understood to include all three modes of navigation. Alternatively, the first video device can be a mobile headset such as a wearable headset and/or headgear. The mobile headset can be worn by an associate of the facility. The first video device can capture images and/or videos from the perspective of the semi-autonomous robotic device and/or associate. The images and/or videos can be transmitted to the first computing system. The first computing system can construct a virtual representation of the facility based at least in part on the captured images and/or videos from the first video device. The images received from the first video device may be used by the first computing system to supplement previously stored images in creating the virtual representation or may be used by themselves to create the virtual representation. The semi-autonomous robotic device and/or associate equipped with the first video device can navigate throughout the facility and the first video device can capture and transmit updated images and/or videos, to the first computing system robotic device during navigation. The first computing system can update the virtual representation of the facility in response to receiving the updated images and/or videos in real time.

The first computing system can transmit the virtual representation to the second computing system and the second computing system can render the virtual representation on a display screen. The hybrid remote retrieval system thus reduces bandwidth consumption, by transmitting the virtual representation and subsequent updates to the second computing system for rendering of the virtual representation in real-time. This approach avoids the need to stream the video of the facility captured by the first video device between the first computing system and second computing system.

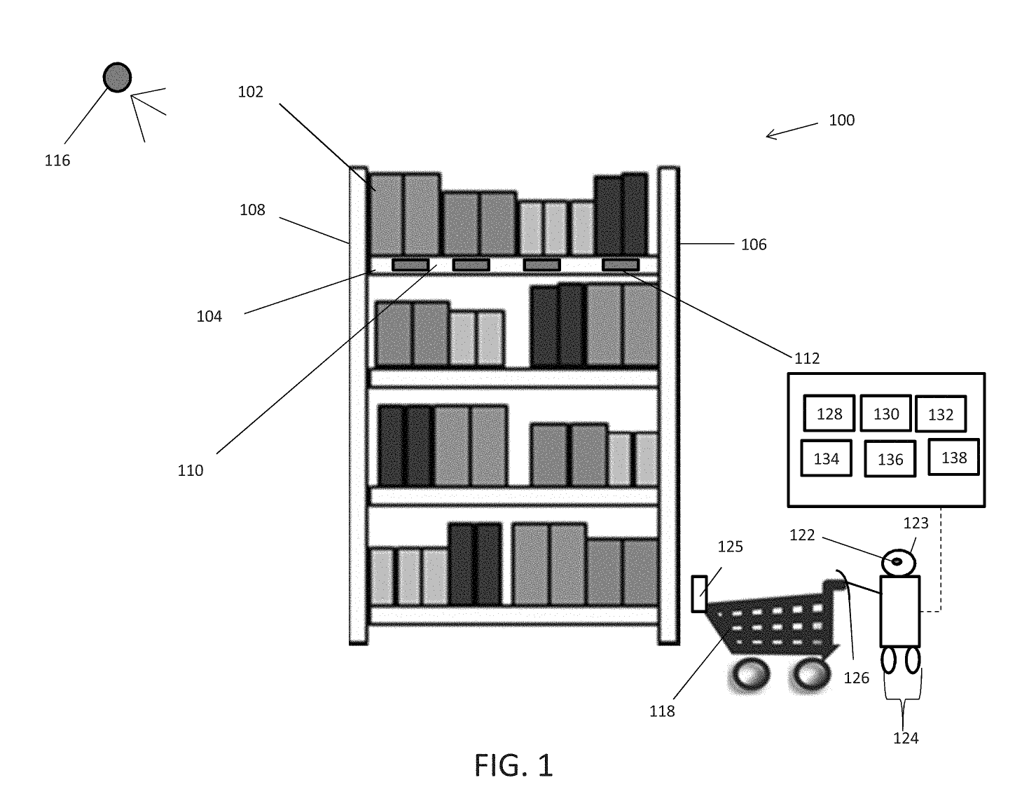

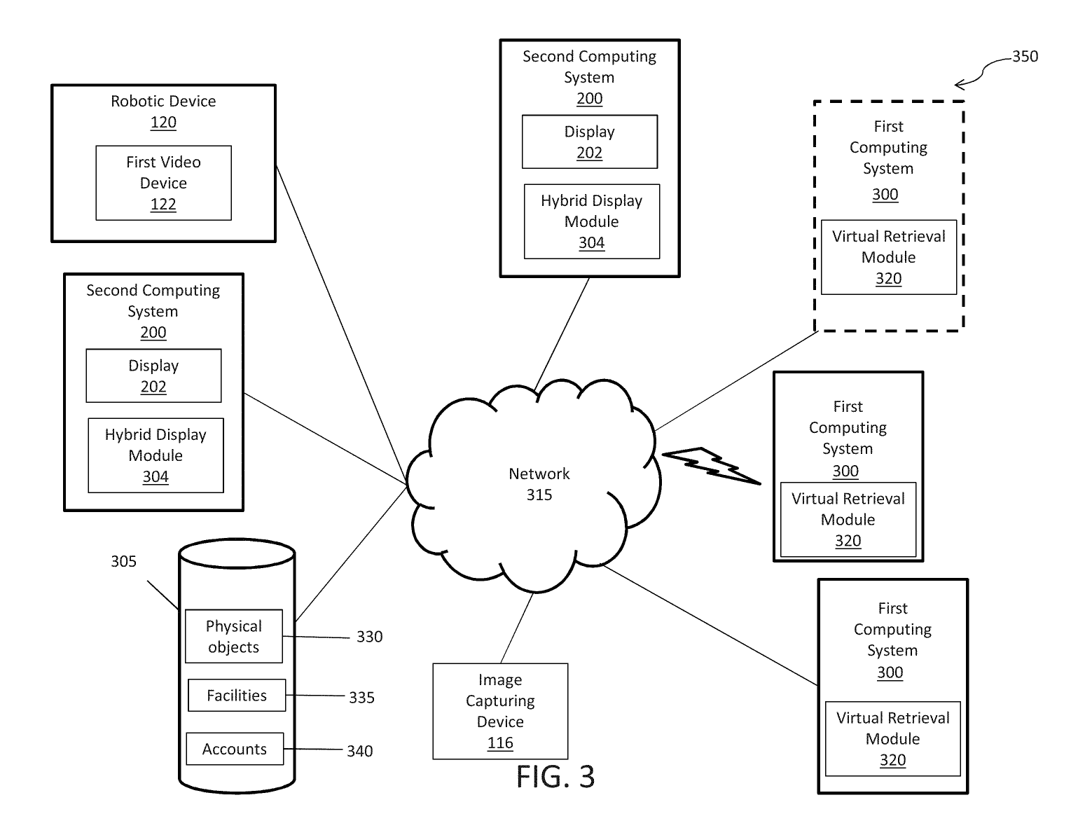

FIG. 1 is a schematic diagram of an exemplary arrangement of physical objects disposed in a facility according to an exemplary embodiment. A shelving unit 100 can include several shelves 104 holding physical objects 102. The shelves 104 can include a top or supporting surface extending the length of the shelf 104. The shelves 104 can also include a front face 110. Labels 112, including machine-readable elements, can be disposed on the front face 110 of the shelves 104. The machine-readable elements can be encoded with identifiers associated with the physical objects disposed on the shelves 104. The machine-readable elements can be barcodes, QR codes, RFID tags, and/or any other suitable machine-readable elements. The machine-readable elements may also appear on individual physical objects. As noted above, first video device 122 can be disposed on a mobile headset 123 worn by an individual. The first video device can alternatively be secured to a semi-autonomous robotic device 120. The semi-autonomous robotic device may also optionally be equipped with a second video device 125 such as, but not limited to, a 360 degree camera. The first video device 122 (and second video device 125) can be configured to capture images and/or videos of the facility as the semi-autonomous robotic device 120 and/or the person with the mobile headset 123 are moving through the facility. The first video device 122 (and second video device 125) can capture images and/or videos continuously. Alternatively, the first video device 122 (and second video device 125) can capture images and/or videos after a predetermined amount of time. The first video device 122 (and second video device 125) can transmit the captured images and/or videos to a first computing system. The first computing system will be discussed in further detail with respect to FIG. 3.

In exemplary embodiments, the semi-autonomous robotic device 120 can receive instructions to pick up physical objects 102 from the shelving unit 100 and deposit the physical objects in a cart 118. The semi-autonomous robotic device 120 can be a driverless vehicle, an unmanned aerial robotic device, an automated conveying belt or system of conveyor belts, and/or the like. Embodiments of the semi-autonomous robotic device 120 can include the first video device 122, motive assemblies 124, a picking unit 126, a controller 128, an optical scanner 130, a drive motor 132, a GPS receiver 134, accelerometer 136 and a gyroscope 138, and can be configured to roam autonomously through the facility. Alternatively, the semi-autonomous robotic device may be configured to follow a store associate's movements. Further, the semi-autonomous robotic device may navigate pursuant to commands received from a remote user as explained further herein. The picking unit 126 can be an articulated arm. The semi-autonomous robotic device 120 can be an intelligent device capable of performing tasks without human control. The controller 128 can be programmed to control an operation of the first video device 122, the optical scanner 130, the drive motor 132, the motive assemblies 124 (e.g., via the drive motor 132), in response to various inputs including inputs from the GPS receiver 134, the accelerometer 136, and the gyroscope 138. The drive motor 132 can control the operation of the motive assemblies 124 directly and/or through one or more drive trains (e.g., gear assemblies and/or belts). In this non-limiting example, the motive assemblies 124 are wheels affixed to the bottom end of the semi-autonomous robotic device 120. The motive assemblies 124 can be but are not limited to wheels, tracks, rotors, rotors with blades, and propellers. The motive assemblies 124 can facilitate 360 degree movement for the semi-autonomous robotic device 120.

The GPS receiver 134 can be an L-band radio processor capable of solving the navigation equations in order to determine a position of the semi-autonomous robotic device 120, determine a velocity and precise time (PVT) by processing the signal broadcasted by GPS satellites. The accelerometer 136 and gyroscope 138 can be used to determine the direction, orientation, position, acceleration, velocity, tilt, pitch, yaw, and roll of the semi-autonomous robotic device 120. In exemplary embodiments, the controller 128 can implement one or more algorithms, such as a Kalman filter and/or SLAM algorithm, for determining a position of the semi-autonomous robotic device.

The semi-autonomous robotic device 120 can navigate around the facility. The first video device 122 can capture images as the semi-autonomous robotic device 120 navigates around the facility. In some embodiments, so that the first video device 122 can capture a full view of the facility, the semi-autonomous robotic device 120 can control the first video device 122 to rotate circumferencely around the x-axis and z-axis up to 360 degrees, and along the y-axis up to 90 degrees. The semi-autonomous robotic device 120 can transmit the captured images and/or videos to the first computing system.

The semi-autonomous robotic device 120 receives instructions to retrieve physical objects 102 and deposit the physical objects in a basket of a cart 118. The instructions can include identifiers associated with the physical objects 102. The semi-autonomous robotic device 120 can query a database to retrieve the designated location of the set of the physical objects 102. The semi-autonomous robotic device 120 can navigate through the facility using the motive assemblies 124 to the physical objects 102. The semi-autonomous robotic device 120 can be programmed with a map of the facility and/or can generate a map of the first facility using simultaneous localization and mapping (SLAM). The semi-autonomous robotic device 120 can navigate around the facility based on inputs from the GPS receiver 134, the accelerometer 136, and/or the gyroscope 138.

Subsequent to reaching the designated location(s) of the physical objects 102, the semi-autonomous robotic device 120 can use the optical scanner 136 to scan the machine readable elements 112 associated with the physical objects 102 respectively. In some embodiments, the semi-autonomous robotic device 120 can capture an image of the machine-readable elements 112 and 114 using the first video device 122. The semi-autonomous robotic device can extract the machine readable element from the captured image using video analytics and/or machine vision.

The semi-autonomous robotic device 120 can extract the identifier encoded in each machine readable element 112. The semi-autonomous robotic device 120 can compare and confirm the identifiers received in the instructions are the same as the identifiers decoded from the machine readable elements 112. The semi-autonomous robotic device 120 can capture images of the physical objects 102 and can use machine vision and/or video analytics to confirm the physical objects 102 are present on the shelving unit 100. The semi-autonomous robotic device 120 can also confirm the physical objects 102 include the physical objects associated with the identifiers by comparing attributes extracted from the images of the physical objects 102 in the shelving unit and stored attributes associated with the physical objects 102.

The semi-autonomous robotic device 120 can pick up a specified quantity of physical objects 102 from the shelving unit 100 using the picking unit 126. The picking unit 126 can include a grasping mechanism to grasp and pickup physical objects. Sensors can be integrated to the grasping mechanism. The semi-autonomous robotic device 120 can carry the physical objects it has picked up to a different location in the facility and/or can deposit the physical objects on an autonomous conveyor belt for transport to a different location in the facility. In an alternative embodiment, the semi-autonomous robotic device may not be equipped with a picking unit 126. In such a case, the semi-autonomous robotic device 120 may navigate to the desired position and a store associate may retrieve the physical object and deposit the physical object into a storage compartment on or in the semi-autonomous robotic device.

Image capturing device(s) 116 can be disposed in the facility. In a non-limiting example, the additional image capturing device 116 can be disposed above the shelving unit 100. The image capturing device(s) 116 can be configured to capture images of the facility. The image capturing device(s) 116 can be an image capturing device configured to capture still or moving images. A first computing system can transmit instructions to capture images of facility. In some embodiments, a single image capturing device 116 can be disposed in the facility. In other embodiments, multiple image capturing devices 116 can be disposed throughout the facility. An example computing system is described in further detail with reference to FIG. 3.

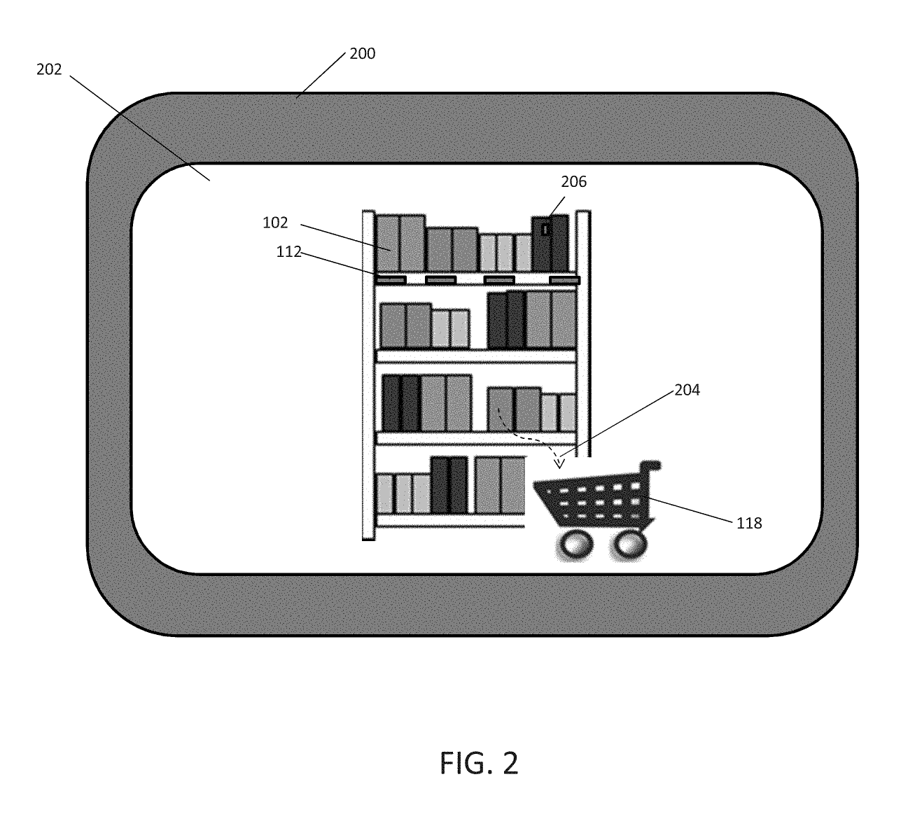

FIG. 2 is a schematic diagram of a virtual representation of the arrangement of physical objects disposed in a facility according to an exemplary embodiment. In exemplary embodiments, a user can transmit a request, via a second computing system 200, to the first computing system 300, to generate a virtual representation of the facility described in FIG. 1. The first and second computing system will be described in greater detail with respect to FIG. 3.

The second computing system 200 can include a display 202. The first computing system 200 can render a virtual representation of the facility on the display 202 of the second computing system 200. The virtual representation can include a virtual representation of the shelving unit 100, physical objects 102, machine-readable elements 112, and a movable storage apparatus such as a cart 118. For ease of explanation the description herein refers to cart 118 but it should be appreciated that other types of movable storage apparatus, such as but not limited to a semi-autonomous robotic device, may be depicted in the virtual representation or deployed in the physical facility without departing from the scope of the present invention.

A user can interact with the second computing system 200 via various input devices and the interactions with the second computing system may be transmitted into corresponding commands sent to the physical facility via the first computing system. For example, the user can select virtual representations of various physical objects 102 using the input devices. The user can select the virtual representations of the physical objects 102 to be deposited into the virtual representation of the cart 118. In response to the user's selection an animation of the virtual representation cart 118 navigating to the selected virtual representation of the physical object 102, and retrieving the physical object can be displayed. The user can control the operation of the virtual representation of the cart 118 using the input devices. For example, the user can navigate the cart around the virtual representation of the facility. The user's operation of the virtual representation of the cart 118 and the selection of the physical objects can be transmitted from the second computing system 200 to the first computing system so corresponding commands can be sent to the physical facility to navigate the semi-autonomous robotic device (or other movable storage apparatus) or to retrieve a corresponding particular physical object.

In some embodiments, the user can change the direction, orientation, position, acceleration, velocity, tilt, pitch, yaw, and roll of the display of the virtual representation of the facility. The virtual representation of the facility can adjust dynamically based on the user's interaction. In some embodiments, an indicator 206 can be displayed on top of a virtual representation of a physical object 102. As a non-limiting example, the user can view the virtual representation of the facility from the vantage point of behind the virtual representation of the handle of the cart 118, to simulate the user operating a cart in a physical facility. Alternatively, the user can change the view to a perspective view of the virtual representations of the cart 118 and facility. The sizes of the virtual representations can be adjusted based on the change in view and/or angle.

FIG. 3 illustrates a hybrid remote retrieval system in accordance with an exemplary embodiment. The a hybrid remote retrieval system 350 can include one or more databases 305, one or more first computing systems 300, one or more second computing systems 200, one or more image capturing devices 116, and one or more robotic devices 120 communicating over communication network 315. The second computing system 200 can include a display 202 and a hybrid display module 304. The hybrid display module can be an executable application residing on the second computing system 200 as described herein. The first computing system 300 can execute one or more instances of a virtual retrieval module 320. The virtual retrieval module 320 can be an executable application residing on the computing system 300 to implement the hybrid remote retrieval system 350 as described herein.

In an example embodiment, one or more portions of the communications network 315 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The first computing system 300 includes one or more computers or processors configured to communicate with the databases 305, the second computing systems 200, the image capturing device 116, and the automated robotic devices 120 via the network 315. The computing system 300 hosts one or more applications configured to interact with one or more components of the hybrid remote retrieval system 350. The databases 305 may store information/data, as described herein. For example, the databases 305 can include a physical objects database 330 and a facilities database 335. The physical objects database 300 can store information associated with physical objects. The facilities database can store information associated with facilities. The information can include a layout of a facility, a plan-o-gram of a facility, a blueprint of a facility, the structure of a facility and/or any other information related to a facility. The databases 305 can be located at one or more geographically distributed locations from the first computing system 300. Alternatively, the databases 305 can be included within the computing system 300.

In one embodiment, the second computing system 200 can execute the hybrid display module 304. The hybrid display module 304 can transmit a request to the first computing system for initiating hybrid retrieval from a facility. The request can include a specified facility. The first computing system 300 can execute the virtual retrieval module 320 in response to receiving the request. The virtual retrieval module 320 can query the facilities database 330 to retrieve information associated with the specified facility. In some embodiments, the virtual retrieval module 320 can capture a location and an identifier of the second computing system 200. The virtual retrieval module 320 can query the facilities database to identify a facility based on the location and an identifier of the second computing system. The virtual retrieval module 320 can retrieve the information associated with the identified facility from the facilities database 330. The virtual retrieval module 320 can also query the physical objects database 335 to retrieve information associated with physical objects disposed in the identified/specified facility.

The virtual retrieval module 320 can identify a semi-autonomous robotic device 120 disposed at the facility. The virtual retrieval module 320 can transmit instructions to the semi-autonomous robotic device 120 to operate a cart including a basket and a handle to a location of the facility. The instructions can also prompt the semi-autonomous robotic device 120 to operate the first video device 122. The first video device 122 can capture images and/or videos of the facility from the perspective of the semi-autonomous robotic device 120, and transmit the images and/or videos to the first computing system 300.

Furthermore, the virtual retrieval module 320 can identify a second video device 125 on the semi-autonomous robotic device 120 providing images or stationary image capturing device(s) 116 disposed in the identified and/or specified facility. In some embodiments the virtual retrieval module 320 can identify more than one image capturing device(s) 116 disposed in the facility. The virtual retrieval module 320 can instruct the second video device 125 or the additional image capturing device(s) 116 to capture images of the facility. The second video device 125 and the image capturing device(s) 116 can transmit the images to the first computing system 300. The virtual retrieval module 320 can construct a virtual representation of the facility based at least in part on the captured images and videos from the first video device 122, second video devices 125 and additional image capturing device 116, the information retrieved from the facilities database 330 and the information retrieved from the physical objects database 335. The virtual representation of the facility can include a virtual representation of the physical objects disposed in the facility, the shelving units, walls, access points, displays, fixtures, and a cart or other movable storage apparatus. The virtual representation of the cart can have a handle and a basket. The virtual representation of the facility can also include virtual representations of labels including machine-readable elements associated with virtual representations of the physical objects. The machine-readable elements can be encoded with identifiers associated with the physical objects corresponding with the virtual representation of the physical objects.

The virtual retrieval module 320 can transmit the virtual representation of the facility to the second computing system 200. The hybrid display module 304 can render the virtual representation of the facility on the display 202. The virtual representation can initially depict the facility from the entrances of the facility. In some embodiments, the virtual representation can initially depict the facility from the perspective from behind a handle of the cart. Alternatively, the hybrid display module 304 can request the first computing system 300 to initially depict a particular portion of the facility. robotic device

The hybrid display module 304 can receive input to operate and navigate the virtual representation of the cart around the virtual representation of the facility. The hybrid display module 304 can simultaneously transmit the received input to the first computing system 300. The virtual retrieval module 320 can instruct the semi-autonomous robotic device 120 to operate and navigate the cart in the facility based on the received input from the hybrid display module 304. The semi-autonomous robotic device 120 can receive the instructions to navigate the cart around the facility, based on the received input. The semi-autonomous robotic device 120 can operate the first video device 122 to capture images and/or videos as the semi-autonomous robotic device 120 navigates around the facility. The semi-autonomous robotic device 120 can transmit the images and/or videos to the first computing system 300. The virtual retrieval module 320 can update the virtual representation of the facility based on the captured images and/or videos. The hybrid display module 304 can display the virtual representation of the cart navigating in the virtual representation of the facility. semi-autonomous robotic device

The hybrid display module 304 can receive input associated with virtual representations of the physical objects. For example, the hybrid display module 304 can receive input associated with a request for information associated with a physical object corresponding to the virtual representation of the physical object. The hybrid display module 304 can determine the identifier of the physical object corresponding to the virtual representation of the physical object. In some embodiments, the hybrid display module 304 can decode the identifier from the virtual representation of a machine-readable element associated with the virtual representation of the physical object. The hybrid display module 304 can transmit the request for information associated with the physical object to the first computing system 300. The request can include an identifier of the physical object corresponding to the virtual representation of the physical object. The virtual retrieval module 320 can query the physical objects database 330 and retrieve the information associated with the physical object. The virtual retrieval module 320 can transmit the information associated with the physical object. The hybrid display module 304 can render the information associated with the physical object on the display 202. In some embodiments, the information can be overlaid on the virtual representation of the physical object corresponding to the physical object. For example, the information may be price or nutrition information for a physical object.

The hybrid display module 304 can also receive input associated with depositing virtual representations of a set of physical objects from the virtual representation of shelving units into the virtual representation of the basket of the cart. In response to receiving the input, the hybrid display module can animate the virtual representations of the set of like physical objects being deposited into the virtual representation of the basket of the cart. The animation can include a specified amount of virtual representations of physical objects based on the received input. The hybrid module can determine the identifiers of the physical objects corresponding to the virtual representations of the physical objects which were deposited in the cart. In some embodiments, the physical objects can include like physical objects with the same identifiers. The hybrid display module can transmit the identifiers and quantity of each set of like physical object to the first computing system 300. The virtual retrieval module 320 can instruct the semi-autonomous robotic device 120 to retrieve (as illustrated and described with respect to FIG. 1) the physical objects based on the received identifiers and deposit the physical objects in the basket of the cart. The virtual retrieval module 320 can keep track of the physical objects which are deposited in the basket of the cart and provide a cumulative cost total.

The hybrid display module 304 can adjust the virtual representation of the facility on the display 202, in response to receiving input. For example, the hybrid display module can depict the different sections of the virtual representation of the facility, as the virtual representation of the cart navigates around the facility. The different sections can include virtual representations of different physical objects, walls, fixtures, displays, and other virtual representations of items and objects disposed in the facility. Furthermore, in response to receiving input associated with depositing virtual representation of physical objects into the virtual representation of basket of a cart, the hybrid display module can adjust the amount of virtual representations of physical objects displayed. As a non-limiting example, in the event a set of five virtual representations of like physical objects are displayed and two are deposited into the virtual representation of the basket of the cart, the hybrid display module 304 can adjust the virtual representation of the facility to display three virtual representations of the set of like physical objects. Furthermore, the hybrid display module 304 can display the two like physical objects in the virtual representation of the basket of the cart.

In some embodiments, the virtual retrieval module 320 can query the accounts database 340 to retrieve information associated with the user of the second computing system 200, using the identifier of the second computing system 200. The information can include physical objects deposited in the cart in previous sessions, age, location, preferences and other information associated with the user. The virtual retrieval module 320 can determine the user's preferences for particular physical objects based on the retrieved information. The virtual retrieval module 320 can transmit instructions to the hybrid display module 304 to render an indicator to be overlaid on particular virtual representations of physical objects. For example, the hybrid control module 304 can change the color of the virtual representation of the physical object, place text over the virtual representation of the physical object and/or place any other indicator over the virtual representation of the physical object.

In some embodiments, in response to receiving a request to initiate a hybrid retrieval session, the virtual retrieval module 320 can transmit instructions to an associate in the facility. The associate can wear a clothing item on which the first video device 122 is secured. The first video device 122 can take images of the facility as the associate navigates the facility. The associate can operate and navigate a cart around the facility and place physical objects into the basket of the cart based on input received by the second computing system 200 as described above. Alternatively, a semi-autonomous robotic device may follow the associate around the facility. The virtual retrieval module 320 can generate the virtual representation of the facility, in real time, in response to receiving the images captured by the first video device 122 worn by the associate. The first video device 122 can be affixed and/or secured to headgear wearable by an associate. It can be appreciated that the first video device 122 can be affixed and/or secured to other clothing items as well.

In some embodiments, the hybrid display module 304 can receive input to control the operation of the image capturing device(s) 116, the first video device 122, the second video device 125 and the semi-autonomous robotic device 120. The hybrid display module 304 can transmit the input to control the operation of the first video device 122, the second video device 125, an additional image capturing device 116 and the semi-autonomous robotic device 120 to the virtual retrieval module 320 on the first computing system 300. The virtual retrieval module 320 can initiate a connection between the semi-autonomous robotic device 120, the first video device 122 or second video device 125 and the second computing system 200. In response to the initiation of the connection, the hybrid display module 304 can receive input to directly control the operation of the semi-autonomous robotic device 120, first video device 122 and second video device 125.

As a non-limiting example, the hybrid remote retrieval system 350 can be implemented in a retail store and/or e-commerce environment. The second computing system 200 can be operated by a customer attempting to initiate an online shopping experience. The customer can execute the hybrid display module 304 on the second computing system 200. The hybrid display module 304 can transmit a request to the first computing system 300 for initiating hybrid retrieval from a retail store. The request can include a specified retail store. The virtual retrieval module 320 can query the facilities database 330 to retrieve information associated with the specified retail sore. In some embodiments, the virtual retrieval module 320 can capture a location and an identifier of the second computing system 200. The virtual retrieval module 320 can query the facilities database to identify a retail store based on the location and an identifier of the second computing system. The virtual retrieval module 320 can retrieve the information associated with the identified retail store from the facilities database 330. The virtual retrieval module 320 can also query the accounts database 340 to retrieve information associated with the customer. The information can include a favorite retail store location and/or the closest retail store in proximity to the home address of the customer. The virtual retrieval module 320 can also query the physical objects database 335 to retrieve information associated with products disposed in the identified/specified retail store.

The virtual retrieval module 320 can identify a semi-autonomous robotic device 120 disposed at the retail store. The virtual retrieval module 320 can transmit instructions to the semi-autonomous robotic device 120 to operate a cart including a basket and a handle to a location of the retail store. The instructions can also prompt the semi-autonomous robotic device 120 to operate the first video device 122. The first video device 122 can capture images and/or videos of the retail store from the perspective of the semi-autonomous robotic device 120, and transmit the images and/or videos to the first computing system 300.

Furthermore, the virtual retrieval module 320 can identify an image capturing device 116 disposed in the identified and/or specified retail store. In some embodiments the virtual retrieval module 320 can identify more than one image capturing device(s) 116 disposed in the retail store. The virtual retrieval module 320 can instruct the image capturing device(s) 116 to capture images of the retail store. The image capturing device(s) 116 can transmit the images to the first computing system 300. The virtual retrieval module 320 can construct a virtual representation of the retail store based on the captured images and videos from the first and second video devices 122, 125 and any additional image capturing devices 116, the information retrieved from the facilities database 330 and the information retrieved from the physical objects database 335. The virtual representation of the retail store can include a virtual representation of the products disposed in the retail store, the shelving units, walls, access points, displays, fixtures, and a cart. The virtual representation of the cart can have a handle and a basket. The virtual representation of the retail store can also include virtual representations of labels including machine-readable elements associated with virtual representations of the products. The machine-readable elements can be encoded with identifiers associated with the products corresponding with the virtual representation of the products.

The customer can also navigate the shopping cart including the products to a virtual representation of a Point-Of-Sale (POS) station. In some embodiments, the hybrid display module 304 can depict an animation of a scanner scanning the machine-readable elements on the products at the POS station. In response to the virtual representations of the products being scanned, the virtual retrieval module 320 can determine a total amount due based on the products placed in the basket of the shopping cart. The second computing system 200 can receive input associated with the payment method and the customer can purchase the products in the shopping cart and complete the transaction. The second computing system 300 can transmit a message to the first computing system indicating the completion of the transaction. The virtual retrieval module 320 can receive the message and mark the products for delivery to a specified address associated with the customer.

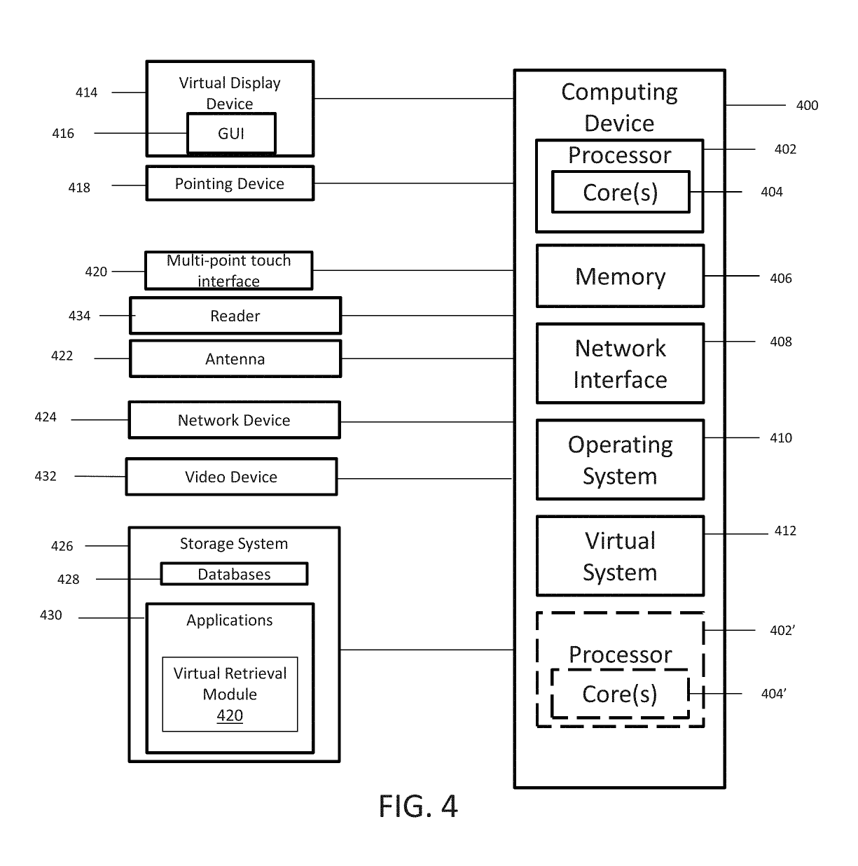

FIG. 4 is a block diagram of an exemplary computing device suitable for implementing embodiments of the hybrid remote retrieval system. The computing device may be, but is not limited to, a smartphone, laptop, tablet, desktop computer, server or network appliance. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 406 included in the computing device 400 may store computer-readable and computer-executable instructions or software (e.g., applications 430 such as the virtual retrieval module 320 and the hybrid display module 304) for implementing exemplary operations of the computing device 400. The computing device 400 also includes configurable and/or programmable processor 402 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for implementing exemplary embodiments of the present disclosure. Processor 402 and processor(s) 402′ may each be a single core processor or multiple core (404 and 404′) processor. Either or both of processor 402 and processor(s) 402′ may be configured to execute one or more of the instructions described in connection with computing device 400.

Virtualization may be employed in the computing device 400 so that infrastructure and resources in the computing device 400 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof. The computing device 400 can receive data from input/output devices such as, a reader 434 and a video device 432.

A user may interact with the computing device 400 through a visual display device 414, such as a computer monitor, which may display one or more graphical user interfaces 416, multi touch interface 420 and a pointing device 418.

The computing device 400 may also include one or more storage devices 426, such as a hard-drive, CD-ROM, or other computer readable media, for storing data and computer-readable instructions and/or software that implement exemplary embodiments of the present disclosure (e.g., applications such as the virtual retrieval module 320 and the hybrid display module 304). For example, exemplary storage device 426 can include one or more databases 528 for storing information regarding the physical objects. The databases 428 may be updated manually or automatically at any suitable time to add, delete, and/or update one or more data items in the databases. The databases 428 can include information associated with physical objects disposed in the facility, information associated with the facilities and information associated with user accounts.

The computing device 400 can include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 422 to facilitate wireless communication (e.g., via the network interface) between the computing device 400 and a network and/or between the computing device 400 and other computing devices. The network interface 408 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run any operating system 410, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 400 and performing the operations described herein. In exemplary embodiments, the operating system 410 may be run in native mode or emulated mode. In an exemplary embodiment, the operating system 410 may be run on one or more cloud machine instances.

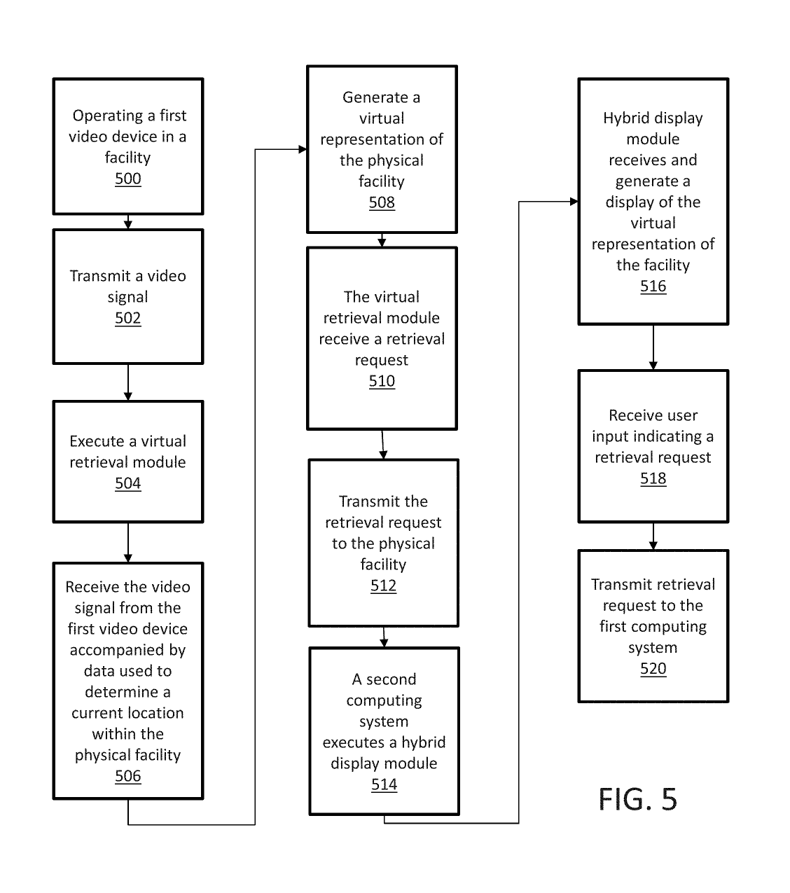

FIG. 5 is a flowchart illustrating a process implemented by a hybrid remote retrieval system according to an exemplary embodiment. In operation 500, a first video device (e.g. first video device 122 as shown in FIGS. 1 and 3) can operate in a physical facility. In operation 502, the first video device can transmit a video signal. In operation 504, a first computing system (e.g. first computing system 300 as shown in FIG. 3) can execute a virtual retrieval module (e.g. virtual retrieval module 320 as shown in FIG. 3). The first computing system is operatively coupled to a database storing information regarding the physical objects. In operation 506, the virtual retrieval module can receive the video signal from the first video device accompanied by data used to determine a current location within the physical facility at which the video signal was generated. In operation 508, the virtual retrieval module can generate a virtual representation of the physical facility including virtual representations of the physical objects (e.g. physical objects 102 as shown in FIGS. 1-2) at locations within the physical facility that are determined based on the video signal and a virtual representation of a movable storage apparatus (e.g. cart 118 as shown in FIGS. 1-2) at the current location within the physical facility. In operation 510, the virtual retrieval module can receive a retrieval request associated with a virtual representation of the physical objects. In operation 512, the virtual retrieval module can transmit the retrieval request to the physical facility. In operation 514, a second computing system (e.g. second computing system 200 as shown in FIGS. 2-3) can execute a hybrid display module (e.g. hybrid display module 304 as shown in FIG. 3). The second computing system can be operatively coupled to the first computing system. In operation 516, the hybrid display module can receive and generate a display of the virtual representation of the facility. In operation 518, the hybrid display module can receive user input indicating a retrieval request. In operation 520, the hybrid display module can transmit retrieval request to the first computing system. The retrieval request is performed in the physical facility and the physical objects are stored in the movable storage apparatus.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A hybrid remote retrieval system comprising:
a first video device configured to operate in a physical facility, the first video device configured to transmit a video signal;
a movable storage apparatus configured to receive a plurality of physical objects and move within the physical facility;
a first computing system operatively coupled to a database holding information regarding the plurality of physical objects, the first computing system configured to execute a virtual retrieval module that when executed:
receives the video signal from the first video device accompanied by data used to determine a current location within the physical facility at which the video signal was generated;
generates a virtual representation of the physical facility including:
virtual representations of the plurality of physical objects at locations within the physical facility that are determined based at least in part on the video signal, and
a virtual representation of the movable storage apparatus at the current location within the physical facility;
transmits the virtual representation of the physical facility to a second computing system,
receives at least one retrieval request associated with a virtual representation of at least one of the plurality of physical objects from the second computing system; and
transmits the at least one retrieval request to the physical facility; and
the second computing system operatively coupled to the first computing system and configured to execute a hybrid display module that when executed:
receives the virtual representation of the physical facility;
generates a display of the virtual representation of the physical facility;
receives user input indicating the at least one retrieval request; and
transmits the at least one retrieval request to the first computing system;
wherein the at least one retrieval request is performed in the physical facility and the at least one of the plurality of physical objects is stored in the movable storage apparatus.

2. The system of claim 1, further comprising:
a semi-autonomous robotic device that includes a controller, a drive motor, an articulated arm and a second video device, and is operatively coupled to the first computing system, the semi-autonomous robotic device configured to:
receive the at least one retrieval request from the first computing system;
navigate to a location of the at least one physical object in the facility;
retrieve the at least one physical object using the articulated arm; and
store the at least one physical object.

3. The system of claim 2, wherein the semi-autonomous robotic device includes an integrated storage space.

4. The system of claim 2, wherein the semi-autonomous robotic device pushes a cart.

5. The system of claim 2, wherein the first computing system is configured to:
receive the current location from the semi-autonomous robotic device.

6. The system of claim 2, wherein the hybrid display module when executed further:
receives input to control the operation of at least one of the first video device, the second video device and the semi-autonomous robotic device; and
transmits the input to control the operation of at least one of the first video device, the second video device and the semi-autonomous robotic device to the virtual retrieval module on the first computing system,
wherein the input to control the operation of at least one of the first video device, the second video device and the semi-autonomous robotic device is transmitted from the first computing system to at least one of an operator of the first video device and the semi-autonomous robotic device.

7. The system of claim 1, wherein the virtual retrieval module is configured to:
extract identifiers associated with the plurality of physical objects from the video signal;
query the database to retrieve information associated with the identifiers; and
render the virtual representations of the plurality of physical objects based on the retrieved information.

8. The system of claim 1, wherein the virtual retrieval module is configured to:
dynamically update a displayed current location of the movable storage apparatus and the plurality of physical objects in the virtual representation of the physical facility; and
transmit the updates to the hybrid display module on the second computing system.

9. A hybrid remote retrieval method comprising:
transmitting, via a first video device operating in a physical facility, a video signal to a first computing system, the first computing system operatively coupled to a database holding information regarding a plurality of physical objects in the physical facility;
executing, via the first computing system a virtual retrieval module;
receiving, via the virtual retrieval module, the video signal from the first video device accompanied by data used to determine a current location within the physical facility at which the video signal was generated;
generating, via the virtual retrieval module, a virtual representation of the physical facility including virtual representations of the plurality of physical objects at locations within the physical facility that are determined based at least in part on the video signal, and a virtual representation of a movable storage apparatus at the current location within the physical facility;
transmitting, via the virtual retrieval module, the virtual representation of the physical facility to a second computing system;
receiving, via the virtual retrieval module, at least one retrieval request associated with a virtual representation of at least one of the plurality of physical objects from the second computing system;
transmitting, via the virtual retrieval module, the at least one retrieval request to the physical facility;
executing a hybrid display module via the second computing system;
receiving, via the hybrid display module, the virtual representation of the physical facility from the first computing system;
generating, via the hybrid display module a display of the virtual representation of the physical facility,
receiving, via the hybrid display module, user input indicating the at least one retrieval request; and
transmitting, via the hybrid display module, the at least one retrieval request to the first computing system,
wherein the at least one retrieval request is performed in the physical facility and the at least one of the plurality of physical objects is stored in the movable storage apparatus.

10. The method of claim 9, further comprising:
receiving, via a semi-autonomous robotic device that includes a controller, a drive motor, an articulated arm and a second video device, the at least one retrieval request from the first computing system;
navigating, via the semi-autonomous robotic device, to a location of the at least one physical object in the facility;
retrieving, via the semi-autonomous robotic device, the at least one physical object using the articulated arm; and
storing, via the semi-autonomous robotic device, the at least one physical object.

11. The method of claim 10, wherein the semi-autonomous robotic device includes an integrated storage space.

12. The method of claim 10, wherein the semi-autonomous robotic device pushes a cart.

13. The method of claim 10, further comprising, receiving, via the first computing system, the current location from the semi-autonomous robotic device.

14. The method of claim 10, further comprising:
receiving, via the hybrid display module, input to control the operation of at least one of the first video device, the second video device and the semi-autonomous robotic device; and
transmitting, via the hybrid display module, the input to control the operation of at least one of the first video device, the second video device and the semi-autonomous robotic device to the virtual retrieval module on the first computing system,
wherein the input to control the operation of at least one of the first video device, the second video device and the semi-autonomous robotic device is transmitted from the first computing system to at least one of an operator of the first video device and the semi-autonomous robotic device.

15. The method of claim 10, further comprising:
extracting, via the virtual retrieval module, identifiers associated with the plurality of physical objects from the video signal;
querying, via the virtual retrieval module, the database to retrieve information associated with the identifiers; and
rendering, via the virtual retrieval module, the virtual representations of the plurality of physical objects based on the retrieved information.

16. The method of claim 10, further comprising:
dynamically updating, via the virtual retrieval module, a displayed current location of the movable storage apparatus and the plurality of physical objects in the virtual representation of the physical facility; and
transmitting, via the virtual retrieval module, the updates to the hybrid display module on the second computing system.
